(19) United States
(12) Patent Application Publication
(10) Pub. No.: US 2026/0370393 A1
(43) Pub. Date: Nov. 19, 2026

(54) INDICATION FOR DYNAMIC HYBRID AUTOMATIC REPEAT REQUEST FEEDBACK

(71) Applicant: Nokia Technologies Oy, Espoo (FI)

(72) Inventors: Tzu-Chung HSIEH, Naperville (IL); Ping Ping WEN, Shanghai (CN); Mads LAURIDSEN, Aalborg (DK); Ping YUAN, Beijing (CN); Jing Yuan SUN, Beijing (CN)

(21) Appl. No.: 19/155,452

(22) PCT Filed: Feb. 16, 2023
(86) PCT No.: PCT/CN2023/076594

§ 371 Date: Aug. 11, 2025

(51) Int. Cl. H04L 1/1812; H04L 1/1825; H04W 72/232

(52) U.S. Cl. CPC H04L 1/1812; H04L 1/1825; H04W 72/232

(57) ABSTRACT

Embodiments of the present disclosure relate to devices, methods, apparatuses and computer readable storage media of indication for dynamic Hybrid Automatic Repeat request (HARQ) feedback. The method comprises obtaining a configuration of dynamic HARQ feedback, wherein the configuration is associated with at least one field comprised in Downlink Control Information (DCI); and determining a pattern of the HARQ feedback based on the configuration information and a detection of the DCI.

### FIELD

Embodiments of the present disclosure generally relate to the field of telecommunication and in particular to devices, methods, apparatuses and computer readable storage media of indication for dynamic Hybrid Automatic Repeat request (HARQ) feedback, and especially to Downlink Control Information (DCI) indication for dynamic HARQ feedback.

### BACKGROUND

HARQ may be implemented in the Medium Access Control (MAC) protocol of Long Term Evolution (LTE) and fifth generation (5G) New Radio (NR) for reliable transfer of transport blocks. For both downlink and uplink, depending on the capability of User Equipment (UE), multiple HARQ processes may run in parallel.

### SUMMARY

In general, example embodiments of the present disclosure provide a solution of indication for dynamic HARQ feedback.

In a first aspect, there is provided an apparatus. The apparatus comprises at least one processor; and at least one memory storing instructions that, when executed by the at least one processor, cause the apparatus at least to obtain a configuration of dynamic HARQ feedback, wherein the configuration is associated with at least one field comprised in DCI; and determine a pattern of the HARQ feedback based on the configuration information and a detection of the DCI.

In a second aspect, there is provided an apparatus. The apparatus comprises at least one processor; and at least one memory storing instructions that, when executed by the at least one processor, cause the apparatus at least to transmit, to a terminal device, a configuration of dynamic HARQ feedback, wherein the configuration is associated with at least one field comprised in DCI.

In a third aspect, there is provide a method. The method comprises obtaining a configuration of dynamic HARQ feedback, wherein the configuration is associated with at least one field comprised in DCI; and determining a pattern of the HARQ feedback based on the configuration information and a detection of the DCI.

In a fourth aspect, there is provide a method. The method comprises transmitting, to a terminal device, a configuration of dynamic HARQ feedback, wherein the configuration is associated with at least one field comprised in DCI.

In a fifth aspect, there is provided an apparatus comprising means for obtaining a configuration of dynamic HARQ feedback, wherein the configuration is associated with at least one field comprised in DCI; and means for determining a pattern of the HARQ feedback based on the configuration information and a detection of the DCI.

In a sixth aspect, there is provided an apparatus comprising means for transmitting, to a terminal device, a configuration of dynamic HARQ feedback, wherein the configuration is associated with at least one field comprised in DCI.

In a seven aspect, there is provided a computer readable medium having a computer program stored thereon which, when executed by at least one processor of an apparatus, causes the apparatus to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIGS. 3A-3D show examples of processes for determining the dynamic HARQ feedback pattern according to some example embodiments of the present disclosure;

FIG. 4 shows a flowchart of an example method of indication for dynamic HARQ feedback according to some example embodiments of the present disclosure;

FIG. 5 shows a flowchart of an example method of indication for dynamic HARQ feedback according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

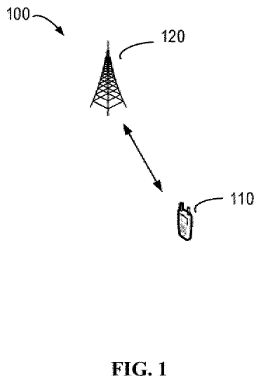

FIG. 1 shows an example communication network 100 in which embodiments of the present disclosure may be implemented. As shown in FIG. 1, the communication network 100 may include a terminal device 110. Hereinafter the terminal device 110 may also be referred to as a UE.

The communication network 100 may further include a network device 120. Hereinafter the network device 120 may also be referred to as a gNB or a eNB. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, for both downlink and uplink, multiple HARQ processes may run in parallel if this scenario is supported by the terminal device.

In the case of DL data transmission, the terminal device may send a one-bit HARQ feedback (Acknowledgement (ACK) or Non-Acknowledgement (NACK)) to report decoding outcome of the Transport Block (TB) received in a HARQ process. Based on the feedback, a network device may retransmit the previous TB or transmit a new TB for the same HARQ process.

In the case of UL data transmission, the network device may schedule a new TB or retransmission based on the decoding status of previous transmission in a HARQ process. This stop-and-wait mechanism within a HARQ process allows the receiver at either terminal device or network device i.e., eNB or gNB, to combine the previously received soft bits with the current retransmission for a more reliable packet decoding.

Especially in a Non-terrestrial Network (NTN) network, due to the long distance between the network device (located in a satellite) and terminal device, the signal round-trip time (RTT) is much longer than in a terrestrial network (e.g., 25.77 ms for LEO at 600 km, 541.46 ms for GEO). For simple Internet of Things (IoT) devices with few HARQ processes, data transmissions in parallel HARQ processes may not fill up the RTT, resulting in the blockage of continuous transmission because all HARQ processes are occupied waiting for response from the transmitter. This “HARQ stalling” problem may impact the achievable user throughput. It has been proposed that the “HARQ stalling” problem may be eliminated by disabling HARQ feedback for IoT over NTN.

Table 1 shows the impact of HARQ stalling and potential gain if HARQ feedback is disabled, considering the deployment scenarios of Geosynchronous Equatorial Orbit (GEO), Low Earth Orbit (LEO) at 1200 km, and LEO at 600 km for NTN. The throughput gain is a result of not waiting for retransmission and saving of HARQ feedback transmission time in case of half-duplex UE.

TABLE 1
DL throughput (in kbps) comparison when HARQ feedback is enabled and disabled

| | Set1, NB-IoT with 2 HARQ processes | | | | | | Set1, NB-IoT with 1 HARQ processes | | | | | |
|---|---|---|---|---|---|---|---|---|---|---|---|---|
| Deployment | GEO | | LEO1200 | | LEO600 | | GEO | | LEO1200 | | LEO600 | |
| Scenario | Center | Edge | Center | Edge | Center | Edge | Center | Edge | Center | Edge | Center | Edge |
| Unused | 91.1 | 86.9 | 15.4 | 12.1 | 0 | 0 | 95.6 | 93.4 | 57.7 | 56.1 | 43.8 | 42 |
| time | | | | | | | | | | | | |
| period | | | | | | | | | | | | |
| [%] | | | | | | | | | | | | |
| Through | 2.4 | 2.3 | 27.4 | 24.9 | 32.4 | 28.3 | 1.2 | 1.2 | 13.7 | 12.5 | 18.2 | 16.4 |
| put with | | | | | | | | | | | | |
| feedback | | | | | | | | | | | | |
| [kbps] | | | | | | | | | | | | |
| Through | 34 | 20 | 42.5 | 35.8 | 42.5 | 35.8 | 34 | 20 | 42.5 | 35.8 | 42.5 | 35.8 |
| put | | | | | | | | | | | | |
| without | | | | | | | | | | | | |
| feedback | | | | | | | | | | | | |
| [kbps] | | | | | | | | | | | | |
| Through | 1310.8 | 773.4 | 55.2 | 43.8 | 31.3 | 26.3 | 2733.3 | 1639.1 | 210.4 | 187.5 | 133.4 | 117.8 |
| put | | | | | | | | | | | | |
| improvement | | | | | | | | | | | | |
| [%] | | | | | | | | | | | | |

The number of HARQ processes in IoT devices may be considerably smaller than those in handset UE. For example, the low-complexity machine type UE requires 8 HARQ processes to operate in coverage enhancement (CE) mode A, 4 HARQ processes in CE mode B, while the NB-IoT devices support only one or two processes. In comparison, NTN capable UE supports 32 HARQ processes. If some HARQ processes are feedback disabled in enhanced Machine Type Communication (eMTC) and Narrowband IoT (NB-IoT) to enhance data throughput, there may not be enough HARQ processes left for control message (e.g., MAC Control Element (MAC CE) and Radio Resource Control (RRC) messages) transmission which require high reliability and acknowledgement for the signaled procedure to take effect.

Currently, for eMTC CE mode A (with 8 HARQ processes), enabling or disabling of HARQ feedback may be configured semi-statically per HARQ process by RRC signalling, while for CE mode B (4 HARQ processes) and NB-IoT (1 or 2 HARQ processes), in addition to the default configuration, DCI may be used to override the default and dynamically enable or disable HARQ feedback.

For UL HARQ operation, like HARQ feedback disabling/enabling in DL, it has been agreed that the counterpart mechanism where HARQ mode A and mode B are supported in IoT NTN.

In HARQ mode A, HARQ uplink retransmissions which always rely on previous PUSCH transmission decoding result (e.g., retransmission triggered only if previous transmission decoded as failure), while in HARQ mode B, HARQ uplink retransmissions which is blindly scheduled by gNB (e.g., retransmission scheduled before availability of initial transmission decoding result).

However, the issue about how to enable and disable HARQ feedback and/or indicate a HARQ feedback pattern dynamically by DCI indication may still need to be discussed.

The solution of the present disclosure proposes a mechanism of DCI indication for dynamic HARQ feedback. In this solution, the terminal device obtains a configuration of dynamic HARQ feedback, which may be associated with at least one field comprised in the DCI. Based on a detection of the DCI and the configuration, the terminal device may determine a pattern of the HARQ feedback.

In this way, the pattern of the HARQ feedback may be indicated by one or more existing field comprised in the DCI without adding a new field and therefore the complexity for terminal device to decode the DCI may not be increased.

Example embodiments of the present disclosure will be described in detail below with reference to the accompanying drawings.

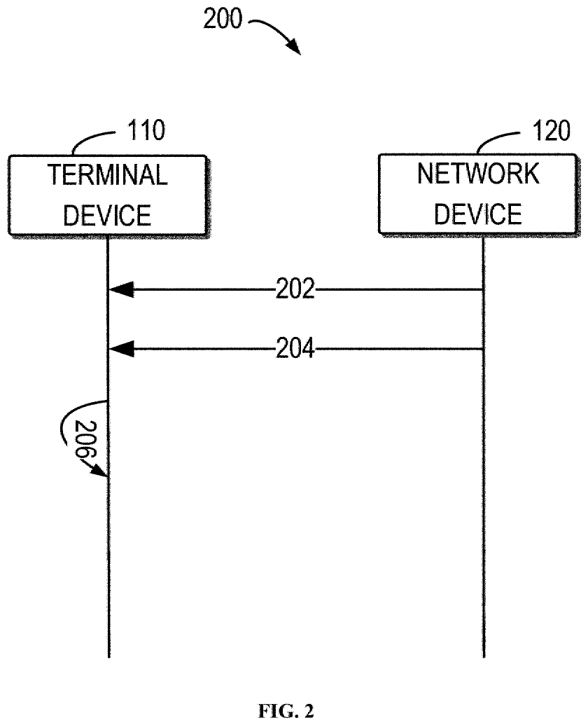

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

The terminal device 110 may obtain a configuration of dynamic HARQ feedback associated with at least one field comprised in the DCI. For example, as shown in FIG. 2, the network device 120 may transmit (202) the configuration of dynamic HARQ feedback to the terminal device 110 a higher layer signalling, for example, via a RRC signaling.

As another option, the configuration may be pre-defined in the specification, which means the terminal device 110 may be aware of this configuration of dynamic HARQ feedback without an explicit signalling from the network device 120.

The terminal device 110 may detect a DCI transmitted (204) from the network device 120 and determine (206) a HARQ feedback pattern based on the DCI and the configuration of dynamic HARQ feedback, which is associated with at least one field in the DCI.

It is to be understood that the HARQ feedback pattern used hereinafter may refer to whether the dynamic HARQ feedback is to be enabled or disabled and/or which HARQ mode, i.e., HARQ mode A or HARQ mode B, is to be applied.

Specifically, both DL and UL HARQ in IoT connection with NTN may use the solution of the present disclosure to override the default HARQ configuration and/or dynamically enable/disable the stop-and-wait protocol in order to provide an acknowledgement for a control message in DL and achieve a higher data rate even with a small number of parallel HARQ processes (e.g., in case of CE mode B and NB-IoT).

For DL HARQ, the HARQ feedback pattern may be switched between “feedback-enabled” and “feedback-disabled” for a HARQ process. For UL HARQ, the the HARQ feedback pattern may be selected between “HARQ mode A” (which follows the stop-and-wait mechanism as described above) and “HARQ mode B” (which schedules the retransmissions without waiting for the decoding result of the previous PUSCH transmission).

Furthermore, it is to be understood that the solution proposed by the present disclosure may also be applied in a terrestrial network.

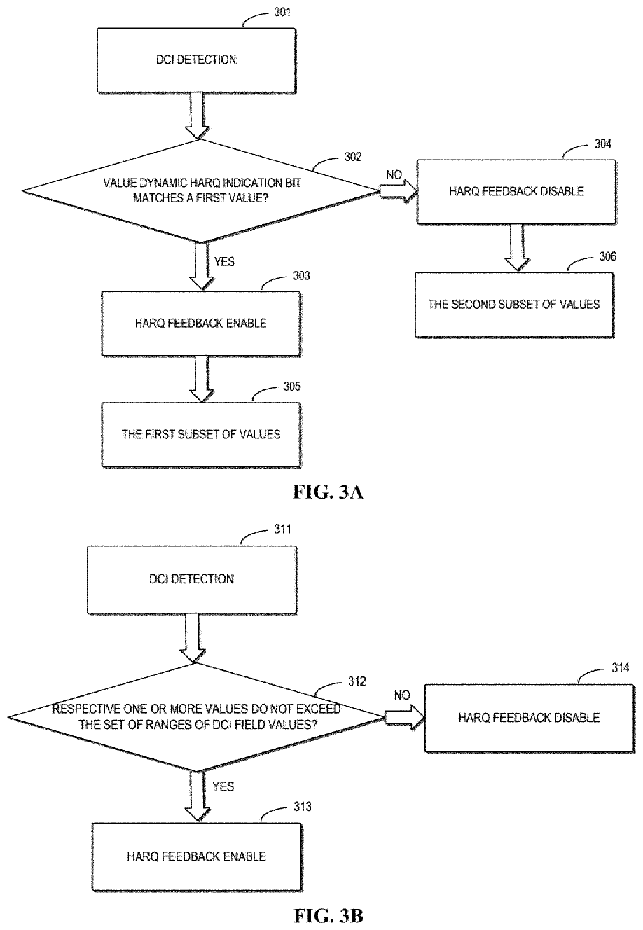

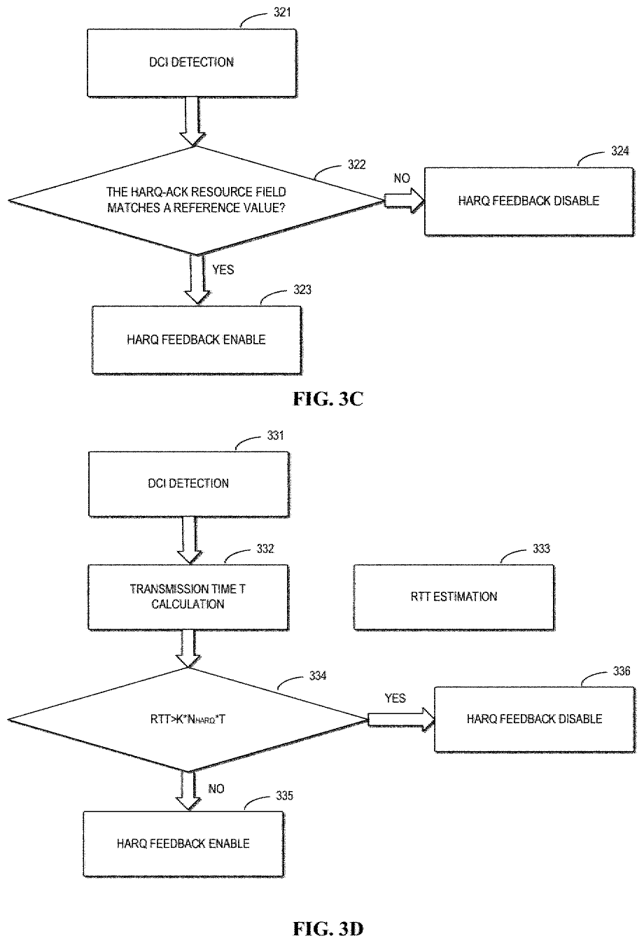

Now the embodiments of the present disclosure may be further described with reference to FIGS. 3A-3D as below.

The size and encoding of DCI are pre-determined according to the format, purpose and assumption. The existing fields in the DCI formats used for CE mode B and NB-IoT downlink and uplink data scheduling may be listed in the following Tables 2-5.

TABLE 2
DCI format 6-0B for PUSCH scheduling used in eMTC CE mode B
DCI format 6-0B for PUSCH scheduling

| | |
|---|---|
| Field | Size (bits) |

| | |
|---|---|
| Flag for 6-0B/6-1B differentiation | 1 |
| Resource block assignment | $⌈ {log}_{2} ⌊ \frac{{N}_{R B}^{UL}}{6} ⌋ ⌉ + 3$ |
| MCS | 4 |
| Repetition number | 3 |
| HARQ process number | 1 |
| NDI | 1 |
| DCI subframe repetition number | 2 |

Note:
${N}_{R B}^{U L} is the allocated number of resource blocks .$

TABLE 3
DCI format 6-1B for PDSCH scheduling used in eMTC CE mode B
DCI format 6-1B for PDSCH scheduling

| Field | Size (bits) |
|---|---|
| Flag for 6-0B/6-1B differentiation | 1 |
| MCS | 4 |
| Resource block assignment | $⌈ {log}_{2} ⌊ \frac{{N}_{R B}^{UL}}{6} ⌋ ⌉ + 1$ |
| Repetition number | 3 |
| HARQ process number | 1 |
| NDI | 1 |
| HARQ-ACK resource offset | 2 |
| DCI subframe repetition number | 2 |

Note:
${N}_{R B}^{D L} is the allocated number of resource blocks .$

TABLE 4
DCI format N0 for NPUSCH scheduling in NB-IoT
DCI Format N0 for NPUSCH scheduling

| Field | Size (bits) |
|---|---|
| Flag for N0/N1 differentiation | 1 |
| Subcarrier indication | 6 |
| Resource assignment | 3 |
| Scheduling delay | 2 |
| MCS | 4 |
| RV | 1 |
| Repetition number | 3 |
| NDI | 1 |
| DCI subframe repetition number | 2 |

TABLE 5
DCI format N1 for NPDSCH scheduling in NB-IoT
DCI format N1 for NPDSCH scheduling

| Field | Size (bits) |
|---|---|
| Flag for N0/N1 differentiation | 1 |
| NPDCCH order indicator | 1 |
| Scheduling delay | 3 |
| Resource assignment | 3 |
| MCS | 4 |
| Repetition number | 4 |
| NDI | 1 |
| HARQ-ACK resource | 4 |
| DCI subframe repetition number | 2 |

As shown in Tables 2-5, multiple existing fields are defined in the DCI format, such as a Modulation and Coding Scheme (MSC) field, a repetition number field, a HARQ-ACK resource field, a resource assignment field, etc.

In some example embodiments, the configuration of dynamic HARQ feedback may indicate that a dynamic HARQ indication bit is configured in a field comprised in the DCI.

For example, the dynamic HARQ indication bit may be configured in the most significant bit (MSB) of a field or the least significant bit (LSB) of a field. As an example, the dynamic HARQ indication bit may be configured in the MSB or the LBS of the MSC field. It is to be understood that other suitable field, such as repetition number field may also be used to indicate the dynamic HARQ indication bit.

Based on the configuration, as shown in FIG. 3A, the terminal device 110 may detect (at block 301) the DCI and determine a value of a certain (e.g., the MSB or the LBS) bit in a field indicated in the configuration. Based on the value, the terminal device 110 may determine (at block 302) whether the HARQ feedback is to be enabled or disable.

For example, if the value of the bit equals to a first value, e.g., 1, the terminal device 110 may determine (at block 303) that the HARQ feedback is enabled. If the value of the bit equals to a second value, e.g., 0, the terminal device 110 may determine (at block 304) that the HARQ feedback is disabled.

Furthermore, the configuration may further indicate that two subsets of the field values. The first subset may be for “feedback-enabled” and the second subset may be for “feedback-disabled”. The size of the subset will be reduced by half from the original set since one bit in the field is used as the dynamic HARQ indication bit. That is, the first and the second subset may be read from the remaining bits in the field other than the dynamic HARQ indication bit. For example, there are 4 bits in the MSC field and if one bit (e.g., the MSB or the LBS) in the MSC field is used to indicate the dynamic HARQ indication bit, the values of the first and the second subsets of the MSC field may be indicated by the remaining 3 bits in the MSC field other than the dynamic HARQ indication bit.

To configure the subsets, the desired link reliability may be considered when HARQ feedback is dynamically enabled for signalling acknowledgement and the expected channel condition when HARQ feedback can be disabled for a higher data rate. For example, when channel condition is bad and a low MCS and a large number of repetitions are required, disabling HARQ feedback may not result in throughput gain.

After determining the HARQ feedback enabled or disabled from the dynamic HARQ indication bit, if the bit indicates feedback-enabled, the terminal device 110 may use (at block 305) the first subset to look up the value of the field while if the bit indicates feedback-disabled, the terminal device 110 may use (at block 306) the second subset to look up the value of the field. The value of the field is indexed by the remaining bits of the field other than the dynamic HARQ indication bit. By using MCS field as an example, the value of the field is indexed by the remaining 3 bits of the MCS field other than the dynamic HARQ indication bit.

It is to be understood that the dynamic HARQ indication bit may alternatively signal whether to override the default feedback configuration. In that case, the feedback-enabled or disabled decision is determined by the indication bit and the default configuration.

In some other example embodiments, the configuration of dynamic HARQ feedback may indicate that a set of ranges of DCI field values for HARQ feedback-enabled or for HARQ feedback-disabled. For example, the used DCI fields may include the MCS field, the repetition number field and/or the resource assignment field, (i.e., the number of subframes or the number of resource units for a TB).

The required resource allocation for data transmission reliability may be considered when HARQ feedback is enabled and when HARQ feedback is disabled, as well as the flexibility of resource allocation. For example, the valid ranges of DCI fields may be configured for HARQ feedback disabled as I_{MCS}>6 for MCS, N_{Rep}<128 for repetition number, and N_{SF}<5 for the number of subframes per TB. The terminal device 110 may simply determine if HARQ feedback should be enabled or disabled based on if the configured feedback-disabled or feedback-enabled condition is met.

As shown in FIG. 3B, the terminal device 110 may detect (at block 311) the DCI and determine the respective one or more values corresponding to at least one field in the DCI. After the comparison of the respective one or more values and the set of ranges of DCI field values, if the terminal device 110 determines (at block 312) the respective one or more values satisfy the set of ranges of DCI field values, e.g., within the set of ranges of DCI field values, the terminal device 110 may determine (at block 313) that HARQ feedback is to be enabled. If not, e.g., the respective one or more values exceed the set of ranges of DCI field values, the terminal device 110 may determine (at block 314) that HARQ feedback is to be disabled.

In addition to the set of ranges of DCI field values, optionally or alternatively, the configuration may indicate that a separate bit in other field can be used to explicit indicate HARQ feedback-enabled or feedback-disabled when the condition is not met. For example, when the condition of the field ranges for HARQ feedback-disabled is not met, 1 bit in the scheduling delay field (as shown in Tables 4 and 5) is used to indicate HARQ feedback-enabled or HARQ feedback-disabled. In that case, the terminal device 110 may use a default value of scheduling delay configured by the network, or a subset of scheduling delay values indexed by the rest of bits in the field.

In some other example embodiments, the configuration of dynamic HARQ feedback may indicate that whether the HARQ feedback is to be enabled based on a value of the HARQ-ACK resource field.

For DL data transmission, the DCI has one field indicating the allocation of HARQ-ACK resource (as shown in Tables 3 and 5). Since the HARQ-ACK resource is needed only when HARQ feedback is enabled, the HARQ feedback-disabled condition may be considered as when the field is set to a certain value. For example, HARQ feedback is disabled if the HARQ-ACK resource field in DCI format N1 has a first value, e.g., value “0000”, for NB-IoT DL transmission. In that case, the terminal device may not report HARQ feedback (i.e., HARQ-ACK). Otherwise, for example, if the HARQ-ACK resource field in DCI format N1 has a value other than the first value, the HARQ feedback may be enabled, and HARQ-ACK is sent in the UL resource indicated by the HARQ-ACK field.

In this case, the network may configure terminal device 110 specific HARQ-ACK resource value for HARQ feedback-disabled indication in order to maintain the flexibility of UL resource assignment for HARQ feedback. Since the designated HARQ-ACK resource value for indicating HARQ feedback-disabled cannot be used for HARQ-ACK resource indication, it would limit UL resource allocation for HARQ feedback. By configuring different values for different terminal devices for HARQ feedback-disabled indication, the network may fully use UL capacity for HARQ feedback transmissions.

As shown in FIG. 3C, the terminal device 110 may detect (at block 321) the DCI and determine the value of the HARQ-ACK resource field. After the comparison of the value of the HARQ-ACK resource field and reference values indicated in the configuration of dynamic HARQ feedback, if the terminal device 110 determines (at block 322) the value of the HARQ-ACK resource field matches a first reference value, the terminal device 110 may determine (at block 323) that HARQ feedback is to be enabled. If the terminal device 110 determines (at block 322) the value of the HARQ-ACK resource field matches a second reference value, the terminal device 110 may determine (at block 324) that HARQ feedback is to be disabled.

In some other example embodiments, the configuration of dynamic HARQ feedback may indicate a scaling factor K for the transmission time, which may control its tolerance for HARQ stalling time. For example, the scaling factor K may be configured with K>1.

Based on the scaling factor K and the data transmission time and the RTT estimated by the terminal device 110, the terminal device 110 may determine the pattern for the HARQ feedback.

As shown in FIG. 3D, the terminal device 110 may detect (at block 331) the DCI and determine the scaling factor K for the transmission time. Also from DCI, the terminal device may estimate (at block 332) data transmission time. For example, in NB-IoT DL, the NPDSCH transmission time is T=N_{TB}N_{Rep} N_{SF}, where N_{TB} is the number of TB scheduled, N_{Rep} the number of repetitions, N_{SF} the number of subframes used by one TB, which may be determined based on the corresponding indication in the DCI.

With N_{HARQ} parallel HARQ processes, the data transmission will not be stalled by the stop-and-wait protocol if the RTT is less than N_{HARQ}T+δ, where δ accounts for the overhead time for PDCCH and processing delay.

For example, for IoT devices supporting NTN connection, as shown in FIG. 3D, one option is the terminal device may estimate (at block 333) the RTT based on ephemeris broadcast from the network device 120 and the own GNSS location data of the terminal device 110 for synchronization and scheduling purposes. Another option is the terminal device may estimate (at block 333) the RTT based on the sum of the UE's Timing Advance value (see TS 36.211, clause 8.1) and k-Mac, The terminal device 110 may need to report its RTT estimate in subframe unit (e.g., Timing Advance (TA) Reporting) to the network device 120 for data scheduling. The network device 120 may use the TA report to determine if HARQ feedback should be expected from the terminal device for the scheduled TB. When the terminal device 110 determines (at block 334) RTT>K·N_{HARO}·T, the terminal device 110 may determines (at block 336) that the HARQ feedback is disabled or the HARQ feedback is to be performed based on the HARQ mode B. Otherwise, the terminal device 110 may determines (at block 335) the HARQ feedback is enabled or the HARQ feedback is to be performed based on the HARQ mode A.

Some of embodiments as described above may also be combined to cause the terminal device 110 to determine the pattern for the HARQ feedback. For example, if the terminal device 110 determines, based on the RTT, scaling factor K and the data transmission, that the condition for HARQ feedback-disabled is not met, the terminal device 110 may check the HARQ feedback indication bit in one of fields (e.g., the MSC field) in the DCI, to determine whether the HARQ feedback is enabled or the HARQ feedback is to be performed based on the HARQ mode A, or the HARQ feedback is disabled or the HARQ feedback is to be performed based on the HARQ mode B.

In this way, the pattern of the HARQ feedback may be indicated by one or more existing field comprised in the DCI without adding a new field and therefore the complexity for terminal device to decode the DCI may not be increased.

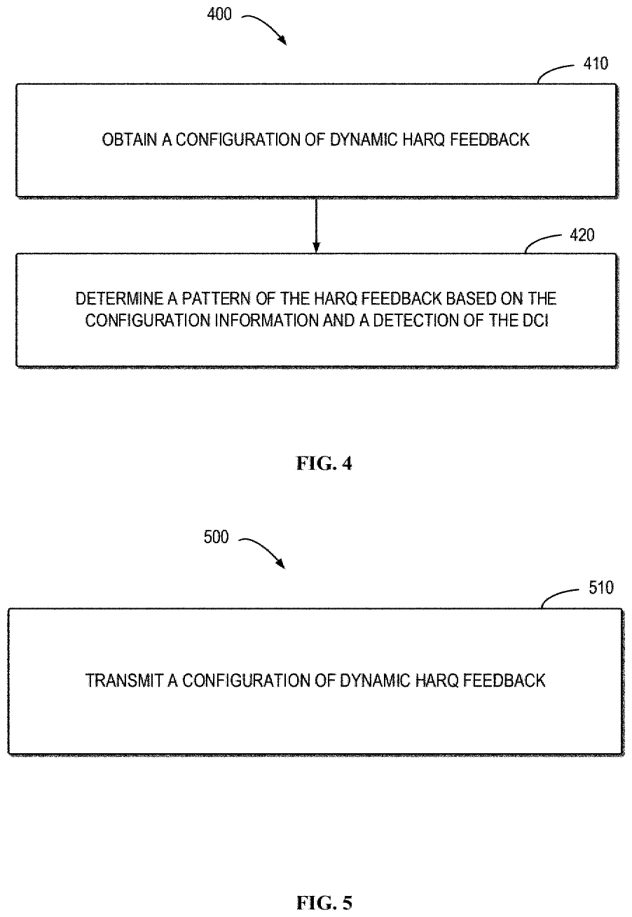

FIG. 4 shows a flowchart of an example method 400 of indication for dynamic HARQ feedback according to some example embodiments of the present disclosure. The method 400 may be implemented at the terminal device 110 as shown in FIG. 1. For the purpose of discussion, the method 400 will be described with reference to FIG. 1.

At 410, the terminal device 110 obtains a configuration of dynamic HARQ feedback. The configuration is associated with at least one field comprised in DCI.

At 420, the terminal device 110 determines a pattern of the HARQ feedback based on the configuration information and a detection of the DCI.

In some example embodiments, the configuration of the HARQ feedback is obtained via a RRC signaling.

In some example embodiments, the configuration indicates that a dynamic HARQ indication bit is configured in a field of the at least one field comprised in the DCI, the terminal device may determine the pattern of the HARQ feedback based on a value of the dynamic HARQ indication bit, wherein the pattern of the HARQ feedback comprises the HARQ feedback is to be enabled or the HARQ feedback is to be performed based on HARQ mode A, or the HARQ feedback is to be disabled or the HARQ feedback is to be performed based on HARQ mode B.

In some example embodiments, the terminal device 110 may obtain, from the configuration, a reference value for a field for HARQ resources in the at least one field in the DCI; and determine the pattern of the HARQ feedback based on the reference value and a value of the field for the HARQ resources detected in the DCI.

In some example embodiments, the dynamic HARQ indication bit is indicated by a most significant bit or the least significant bit of the field.

In some example embodiments, if the terminal device 110 determines that the HARQ feedback is to be enabled, the terminal device may determine a value of the field based on a first subset of field values in remaining bits in the field other than the dynamic HARQ indication bit.

In some example embodiments, if the terminal device 110 determines that the HARQ feedback is to be disabled, the terminal device may determine the value of the field based on a second subset of field values in the remaining bits in the field other than the dynamic HARQ indication bit.

In some example embodiments, the configuration indicates respective one or more ranges of values for the at least one field in the DCI, if the terminal device 110 determines that a value of the at least one field satisfies the respective one or more ranges of values, the terminal device may determine that the HARQ feedback is to be enabled; or if the terminal device 110 determines that the value of the at least one field does not satisfy the respective one or more ranges of values, the terminal device may determine that the HARQ feedback is to be disabled.

In some example embodiments, the at least one field in the DCI comprises at least one of the following: a MCS field, a repetition number field, a resource assignment field, or a HARQ-Acknowledgment resource field.

In some example embodiments, the configuration indicates a scaling factor for a transmission time, the terminal device may determine the data transmission time based on the DCI; and determine the pattern of the HARQ feedback based on a comparison of a RTT between the apparatus and a network device with a product of the data transmission time, the number of HARQs and the scaling factor.

In some example embodiments, if the terminal device 110 determines that the RTT exceeds the product, the terminal device may determine that HARQ feedback is to be disabled or the HARQ feedback is to be performed based on HARQ mode B.

In some example embodiments, if the terminal device 110 determines that the RTT does not exceed the product, the terminal device may determine that HARQ feedback is to be enabled or the HARQ feedback is to be performed based on HARQ mode A.

FIG. 5 shows a flowchart of an example method 500 of indication for dynamic HARQ feedback according to some example embodiments of the present disclosure. The method 500 may be implemented at the network device 120 as shown in FIG. 1. For the purpose of discussion, the method 500 will be described with reference to FIG. 1.

At 510, the network device 120 transmits, to a terminal device, a configuration of dynamic HARQ feedback, wherein the configuration is associated with at least one field comprised in DCI.

In some example embodiments, the configuration of the HARQ feedback is transmitted via a RRC signaling.

In some example embodiments, the configuration indicates at least one of the followings: a dynamic HARQ indication bit is configured in a field of the at least one field comprised in the DCI, respective one or more ranges of values for the at least one field in the DCI, or a scaling factor for a transmission time.

In some example embodiments, the dynamic HARQ indication bit is configured in the field of the at least one field comprised in the DCI, the configuration indicates: a value of the field is determined based on a first subset of field values in remaining bits in the field other than the dynamic HARQ indication bit if the HARQ feedback is to be enabled; and the value of the field is determined based on a second subset of field values in remaining bits in the field other than the dynamic HARQ indication bit if the HARQ feedback is to be disabled.

In some example embodiments, the configuration indicates that the HARQ feedback is to be disabled if a value of the at least one field does not satisfy the respective one or more ranges of values for the at least one field in the DCI.

In some example embodiments, the at least one field in the DCI comprises at least one of the following: a MCS field, a repetition number field, a resource assignment field, or a HARQ-Acknowledgment resource field.

In some example embodiments, an apparatus capable of performing the method 400 (for example, implemented at the terminal device 110) may include means for performing the respective steps of the method 400. The means may be implemented in any suitable form. For example, the means may be implemented in a circuitry or software module.

In some example embodiments, the apparatus comprises means for obtaining a configuration of dynamic HARQ feedback, wherein the configuration is associated with at least one field comprised in DCI; and means for determining a pattern of the HARQ feedback based on the configuration information and a detection of the DCI.

In some example embodiments, an apparatus capable of performing the method 500 (for example, implemented at the network device 120) may include means for performing the respective steps of the method 500. The means may be implemented in any suitable form. For example, the means may be implemented in a circuitry or software module.

In some example embodiments, the apparatus comprises means for transmitting, to a terminal device, a configuration of dynamic HARQ feedback, wherein the configuration is associated with at least one field comprised in DCI.

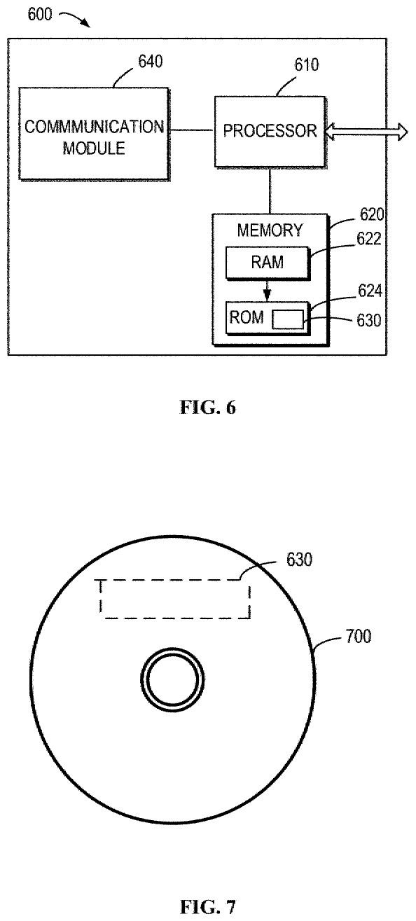

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
obtain a configuration of dynamic Hybrid Automatic Repeat request, HARQ, feedback, wherein the configuration is associated with at least one field comprised in downlink control information, DCI; and
determine a pattern of the HARQ feedback based on the configuration information and a detection of the DCI.

2. The apparatus of claim 1, wherein the configuration of the HARQ feedback is obtained via a Radio Resource Control, RRC, signaling.

3. The apparatus of claim 1, wherein the configuration indicates that a dynamic HARQ indication bit is configured in a field of the at least one field comprised in the DCI, and wherein the apparatus is caused to:
determine the pattern of the HARQ feedback based on a value of the dynamic HARQ indication bit, wherein the pattern of the HARQ feedback comprises the HARQ feedback is to be enabled or the HARQ feedback is to be performed based on HARQ mode A, or the HARQ feedback is to be disabled or the HARQ feedback is to be performed based on HARQ mode B.

4. The apparatus of claim 3, wherein the dynamic HARQ indication bit is indicated by a most significant bit or the least significant bit of the field.

5. The apparatus of claim 3, wherein the apparatus is caused to:
in accordance with a determination that the HARQ feedback is to be enabled, determine a value of the field based on a first subset of field values in remaining bits in the field other than the dynamic HARQ indication bit; or
in accordance with a determination that the HARQ feedback is to be disabled, determine the value of the field based on a second subset of field values in the remaining bits in the field other than the dynamic HARQ indication bit.

6. The apparatus of claim 1, wherein the configuration indicates respective one or more ranges of values for the at least one field in the DCI, and wherein the apparatus is caused to:
in accordance with a determination that a value of the at least one field satisfies the respective one or more ranges of values, determine that the HARQ feedback is to be enabled or the HARQ feedback is to be performed based on HARQ mode A; or
in accordance with a determination that the value of the at least one field does not satisfy the respective one or more ranges of values, determine that the HARQ feedback is to be disabled or the HARQ feedback is to be performed based on HARQ mode B.

7. The apparatus of claim 1, wherein the apparatus is caused to:
obtain, from the configuration, a reference value for a field for HARQ resources in the at least one field in the DCI; and
determine the pattern of the HARQ feedback based on the reference value and a value of the field for the HARQ resources detected in the DCI.

8. The apparatus of claim 1, wherein the at least one field in the DCI comprises at least one of the following:
a Modulation and Coding Scheme, MCS, field,
a repetition number field,
a resource assignment field, or
a HARQ-Acknowledgment resource field.

9. The apparatus of claim 1, wherein the configuration indicates a scaling factor for a transmission time, and wherein the apparatus is caused to:
determine the data transmission time based on the DCI; and
determine the pattern of the HARQ feedback based on a comparison of a round trip time, RTT, between the apparatus and a network device with a product of the data transmission time, the number of HARQs and the scaling factor.

10. The apparatus of claim 9, wherein the apparatus is further caused to:
in accordance with a determination that the RTT exceeds the product, determine that the HARQ feedback is to be disabled or the HARQ feedback is to be performed based on HARQ mode B; or
in accordance with a determination that the RTT does not exceed the product, determine that the HARQ feedback is to be enabled or the HARQ feedback is to be performed based on HARQ mode A.

11. An apparatus comprising:
at least one processor; and
at least one memory storing instructions that, when executed by the at least one processor, cause the apparatus at least to:
transmit, to a terminal device, a configuration of dynamic Hybrid Automatic Repeat request, HARQ, feedback, wherein the configuration is associated with at least one field comprised in downlink control information, DCI.

12. The apparatus of claim 11, wherein the configuration of dynamic HARQ feedback is transmitted via a Radio Resource Control, RRC, signaling.

13. The apparatus of claim 11, and wherein the configuration indicates at least one of the followings:
a dynamic HARQ indication bit is configured in a field of the at least one field comprised in the DCI,
respective one or more ranges of values for the at least one field in the DCI,
a scaling factor for a transmission time, or
a reference value for a field for HARQ resources.

14. The apparatus of claim 13, wherein the dynamic HARQ indication bit is configured in the field of the at least one field comprised in the DCI, and wherein the configuration indicates:
a value of the field is determined based on a first subset of field values in remaining bits in the field other than the dynamic HARQ indication bit if the HARQ feedback is to be enabled; and
the value of the field is determined based on a second subset of field values in remaining bits in the field other than the dynamic HARQ indication bit if the HARQ feedback is to be disabled.

15. The apparatus of claim 13, wherein the configuration indicates that the HARQ feedback is to be disabled if a value of the at least one field does not satisfy the respective one or more ranges of values for the at least one field in the DCI.

16. The apparatus of claim 11, wherein the at least one field in the DCI comprises at least one of the following:
a Modulation and Coding Scheme, MCS, field,
a repetition number field,
a resource assignment field, or
a HARQ-Acknowledgment resource field.

17. A method comprising:
obtaining a configuration of dynamic HARQ feedback, wherein the configuration is associated with at least one field comprised in DCI; and
determining a pattern of the HARQ feedback based on the configuration information and a detection of the DCI.

18-21. (canceled)
